(19) United States
(12) Patent Application Publication
(10) Pub. No.: US 2021/0318026 A1
(43) Pub. Date: Oct. 14, 2021

(54) HEATING DEVICE

(71) Applicant: WEBASTO SE, Stockdorf (DE)

(72) Inventors: Daniel Eckert, Stockdorf (DE); Alexander Henne, Stockdorf (DE); Fritz Wegener, Stockdorf (DE)

(21) Appl. No.: 16/769,898

(22) PCT Filed: Nov. 30, 2018
(86) PCT No.: PCT/EP2018/083109

§ 371 Date: Jun. 4, 2020

(30) Foreign Application Priority Data
Dec. 6, 2017 (DE) 10 2017 129 026.5

(51) Int. Cl. F24H 3/04; F24H 9/20; H05B 1/02; H05B 3/56; H01R 12/77

(52) U.S. Cl. CPC F24H 3/0429; F24H 9/2014; F24H 9/2071; H05B 2203/016; H05B 3/56; H01R 12/771; H05B 1/0236

(57) ABSTRACT

A heating device for a vehicle includes a heat exchanger and an electronic control unit controlling operating states of the heating device. The electronic control unit has at least one electrical connection contact on a printed circuit board. At least one connecting cable is electrically conductively connected to the at least one electrical connecting contact and runs at least in sections parallel to a surface of the printed circuit board within the heating device. A metal sheet is arranged between the at least one connecting cable and the printed circuit board.

This application represents the national stage entry of PCT International Application No. PCT/EP2018/083109 filed Nov. 30, 2018, which claims priority to German Patent Application DE 10 2017 129 026.5 filed Dec. 6, 2017. Each of these applications is incorporated herein by reference in its entirety for all purposes.

The present disclosure relates to a heating device, in particular a heating device for a vehicle.

Heating devices, in particular heating devices for vehicles, usually have an electronic control unit which controls the operating states of the heating device and is supplied with power. Furthermore, an electrical heating element can be arranged in the heating device as a thermal heating source of the heating device, either alone or in combination with another heating source, which is controlled by the electronic control unit. The electrical connection contacts required for the power supply of the electronic control unit and the electrical heating element, if present, are usually electrically contacted by connecting cables which can emit non-negligible electromagnetic emissions during the operation of the heating device and which can severely impair the function of the electronic control unit of the heating device itself as well as the function of any adjacent electronic components.

The present disclosure has the object to solve this problem in a cost-effective manner, at least for the heating device itself, which at the same time has a beneficial effect on the ease of installation and maintenance of the heating device.

Described is a heating device, in particular for a vehicle. The heating device comprises a heat exchanger and an electronic control unit controlling operating states of the heating device. The electronic control unit has at least one electrical connection contact on a printed circuit board. At least one connecting cable is electrically conductively connected to the at least one electrical connecting contact. Furthermore, the at least one connecting cable runs at least in sections parallel to a surface of the printed circuit board within the heating device, wherein a metal sheet is arranged between the at least one connecting cable and the printed circuit board. The metal sheet is electrically conductive and acts as an electromagnetic shield for electromagnetic radiation emitted by the connecting cable. In this way the printed circuit board of the electronic control unit controlling the heating device with the electronic components arranged thereon can be reliably shielded against the emitted electromagnetic radiation. The metal sheet can be, for example, a thin aluminum sheet or a thin steel sheet. The at least one electrical connection contact can be used, for example, to supply power to the electronic control unit or to supply power to an electrical heating element. Therefore, electrical connecting contacts for the power supply of the electronic control unit as well as electrical connecting contacts for the power supply of a possibly existing electrical heating element controlled by the control unit can be arranged on the printed circuit board. By providing the metal sheet between the connecting cable and the printed circuit board, it is possible to omit a separate electromagnetic shield of the at least one connecting cable. In this way, the connecting cable can be made thinner in its overall cross-section and more flexible in terms of its flexibility, thus simplifying maintenance and installation.

Advantageously, it is provided that the metal sheet forms a u-shaped channel with two lateral side walls, wherein the at least one connecting cable is guided by the metal sheet in the u-shaped channel. In this way, the metal sheet used for electromagnetic shielding can provide a cable guide for the at least one connecting cable at the same time, which simplifies installation and maintenance of the heating device. The design as a u-shaped channel with two lateral side walls also provides an advantageous electromagnetic “shadow” compared to a simple flat metal sheet, so that the metal sheet can be made smaller where appropriate.

Advantageously, a metallic cover is provided, which at least partially covers the u-shaped channel. Due to the metallic cover, an electromagnetic radiation from the at least one connecting cable in the now closed cable duct can be essentially completely prevented, so that an undesired electromagnetic interference of other electronic components located in the vicinity, which may not belong to the heating device, can also be reliably ruled out.

Further, the metallic cover may be a component separate from the metal sheet. Alternatively, it may be considered that the metallic cover is part of the metal sheet. A separate cover may, for example, include/have a simple metallized foil, which does not result in a significant increase in weight due to the metal cover. If, on the other hand, the metal cover is part of the metal sheet, the cable duct produced from the metal sheet can be of a particularly simple design, whereby, for example, the cable duct can have a substantially rectangular cross-section and the metal cover covering the u-shaped channel at least partially can be easily bent “up” and “down” to open or close the u-shaped channel.

Furthermore, it may be provided that the metal sheet is attached to the heat exchanger through the printed circuit board. By attaching the metal sheet directly to the heat exchanger, it is possible to ground the metal sheet to the potential of the heat exchanger at the same time. The metal sheet can be fixed to the heat exchanger with a simple metal screw, for example. Since the metal sheet is fastened to the heat exchanger through the PCB, the fastener used for the metal sheet can be used to fix the PCB to the heat exchanger at the same time, so that separate fastening elements for fixing the PCB relative to the heat exchanger are not necessary.

Advantageously, it may be provided that the at least one connecting cable has no electromagnetic shielding. Since the metal sheet already provides electromagnetic shielding, there is no need for a further electromagnetic shielding of the connecting cable itself, so that the overall cross-section of the cable can be thinner and more flexible.

In the following, the present disclosure will be explained by means of preferred embodiments by way of example.

It shows:

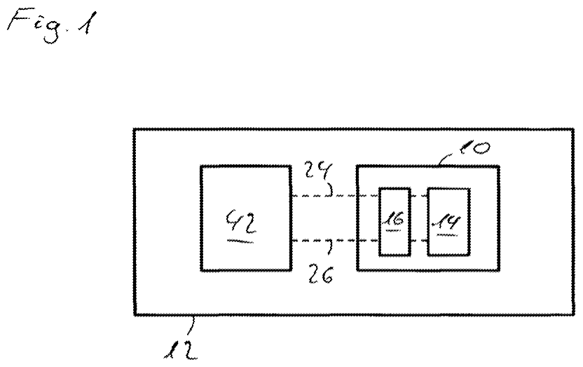

FIG. 1 a schematic representation of a vehicle with a heating device;

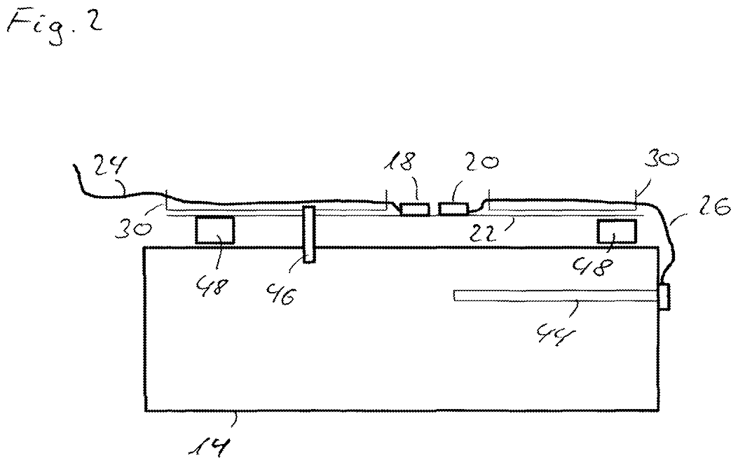

FIG. 2 a schematic side view of a heating device;

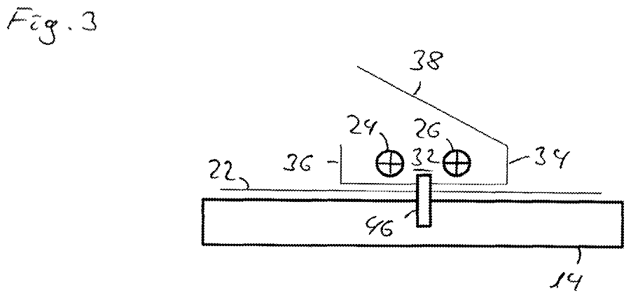

FIG. 3 another schematic side view of a heating device; and

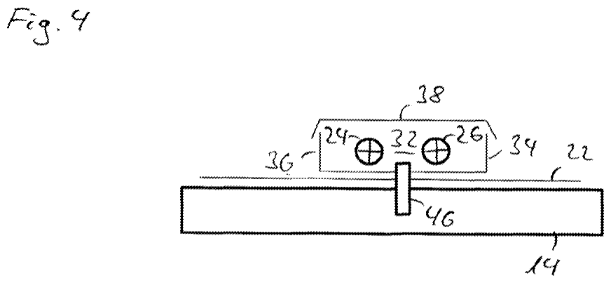

FIG. 4 a third schematic side view of a heating device.

In the following description of the drawings, identical reference numerals indicate identical or comparable components.

FIG. 1 shows a schematic representation of a vehicle 12 with a heating device 10. Vehicle 12, which is only schematically indicated in FIG. 1, includes a power source 42, which may, for example, represent the primary energy supply of the entire vehicle 12. The vehicle 12 can then be, for example, an all-electric motor vehicle. The power source 42 is electrically connected to the heating device 10 via connecting cables 24, 26 in order to supply it with power. The heating device 10 has an electronic control unit 16 as well as a heat exchanger 14, whereby the heat exchanger 14 in the present case may, for example, be electrically heated and may be used to heat a medium, for example water, air or a water-alcohol mixture.

FIG. 2 shows a schematic side view of components of a heating device. Shown is a printed circuit board 22 of the unspecified electronic control unit 16 and the heat exchanger 14. Other components, such as an additional enclosure as the housing of the printed circuit board 22 and thus as housing of the unspecified electronic control unit, media supply and discharge in the area of the heat exchanger 14, any circulation pumps or fans that may be required and other components that are usually present in a heating device are not shown to simplify the Figure. Electrical connection contacts 18, 20 are arranged on the printed circuit board 22, which are electrically connected to connection cables 24, 26. In the present case, the electrical connecting cable 24 can, for example, serve to supply power to components arranged on the printed circuit board 22 and the further connecting cable 26 can serve to supply power to an electrical heating element 44 arranged in the area of the heat exchanger 14, which is electrically conductively connected to the connecting cable 26 via an unspecified further electrical connecting contact. The connecting cable 24 and the connecting cable 26 can be routed at least in sections parallel along the surface of the printed circuit board, whereby between the printed circuit board 22 and the connecting cable 24 and the connecting cable 26 in FIG. 2 a metal sheet 30 is arranged in each case. It is conceivable that only a single metal sheet 30 is used. During operation of the heating device the metal sheet 30 shields the electromagnetic radiation from the connecting cable 24 and the connecting cable 26 from the printed circuit board 22. In this way, any impairment of the functionality of electronic components on the printed circuit board 22 such as ICs not shown can be excluded. The metal sheet 30 can, for example, be connected to the heat exchanger 14 through the printed circuit board 22 by means of a fastening element 46, whereby in particular an electrically conductive connection can also be established between the metal sheet 30 and the heat exchanger 14, so that the potential of the metal sheet is adjusted to the potential of the heat exchanger 14. The fastening element 46 can be a simple screw, for example. Further fastening elements, especially fastening elements for the spatial definition of the metal sheet 22 in relation to the heat exchanger 14 can be omitted. Distance elements 48 can be provided between the printed circuit board 22 and the heat exchanger 14, which ensure a minimum distance between the printed circuit board 22 and the heat exchanger 14. In this way an undesirable overheating of the printed circuit board 22 by direct thermal contact with the heat exchanger 14 can be prevented.

FIG. 3 shows a second schematic side view of components of a heating device 10. In the schematic side view shown in FIG. 3, side walls 34, 36 can be seen in connection with the metal sheet 30, which shields the printed circuit board 22 from electromagnetic radiation from the connecting cables 24, 26, so that the metal sheet forms a substantially u-shaped channel 32, in which the connecting cables 24, 26 can be guided at least in sections along the surface of the printed circuit board 22. In addition, a metallic cover 38 is provided, which can be manufactured integrally together with the remaining components of the u-shaped channel 32. The metallic cover 38 can, for example, be integrally formed as an extension of the side wall 34, whereby the metallic cover 38 can be bent upwards or downwards to open or close the u-shaped channel 32. In the closed state, that is, when the metallic cover 38 is bent downwards, the connecting cables 24, 26 are located in a channel with an essentially rectangular cross-section, whereby the connecting cables 24, 26 are surrounded on all sides by the metal sheet and emitting of electromagnetic radiation can be essentially completely prevented.

FIG. 4 shows a third schematic side view of components of a heating device. The schematic side view shown in FIG. 4 is largely similar to the representation already known from FIG. 3, although the metallic cover 38 is a separate component and can, for example, be placed and fixed in the form of a lid part on the u-shaped channel 32. The metallic cover 38 can, for example, be formed by a metallized foil, so that, despite the essentially complete suppression of electromagnetic radiation compared with an open formation of the u-shaped channel 32, there are practically no negative effects with regard to the weight of the heating device.

The features disclosed in the above description, the drawings and the claims may be incorporated either individually or in any combination.

### REFERENCE NUMERALS

10 heating device
12 vehicle
14 heat exchanger
16 electronic control unit
18 electrical connection contact
20 electrical connection contact
22 printed circuit board
24 connection cable
26 connection cable
30 metal sheet
32 u-shaped channel
34 side wall
36 side wall
38 metallic cover
40 fastening element
42 power source
44 electrical heating element
46 fastening element
48 distance element

1. A heating device for a vehicle, comprising a heat exchanger and an electronic control unit controlling operating states of the heating device;
wherein the electronic control unit has at least one electrical connection contact on a printed circuit board;
wherein at least one connecting cable is electrically conductively connected to the at least one electrical connecting contact;
wherein the at least one connecting cable (24, 26) runs at least in sections parallel to a surface of the printed circuit board within the heating device; and
wherein a metal sheet is arranged between the at least one connecting cable and the printed circuit board.

2. The heating device according to claim 1, wherein the metal sheet forms a u-shaped channel with two lateral side walls, and wherein the at least one connecting cable is guided by the metal sheet in the u-shaped channel.

3. The heating device according to claim 2, wherein a metallic cover is provided which at least partially covers the u-shaped channel.

4. The heating device according to claim 3, wherein the metallic cover is a component separate from the metal sheet.

5. The heating device according to claim 3, wherein the metallic cover is part of the metal sheet.

6. The heating device according to claim 1, wherein the metal sheet is attached to the heat exchanger through the printed circuit board.

7. The heating device according to claim 1, wherein the at least one connecting cable has no electromagnetic shielding.
